(19) United States
(12) Patent Application Publication
(10) Pub. No.: US 2011/0214320 A1
(43) Pub. Date: Sep. 8, 2011

(54) FLOWGUIDE DECORATION

(75) Inventors: David Arthur Glickson, Evanston, IL (US); Victor J. Hawkins, Castle Rock, CO (US)

(73) Assignee: Diogen Lighting. Inc., Centennial, CO (US)

(21) Appl. No.: 12/715,963

(22) Filed: Mar. 2, 2010

(51) Int. Cl. G09F 19/00; G09F 19/02

(52) U.S. Cl. 40/406

(57) ABSTRACT

A flowguide decoration has a viewing vessel filled with fluid and decorative particles. The flowguide decoration also contains a flowguide positioned within the viewing vessel. The flowguide in combination with the viewing vessel defines a flow path for movement of the fluid and the decorative particles within the viewing vessel. A motor-driven impeller is also contained within the flowguide decoration, which imparts motion to the fluid and the decorative particles along the flow path when the impeller is rotating. A light that illuminates one or more of the viewing vessel, flowguide, fluid, and decorative particles; a speaker that plays one or more of songs, sounds, and voices; a battery that powers one or more of the light, speaker, and motor-driven impeller; and/or circuitry that controls one or more of the light, speaker, and motor-driven impeller may also be included.

### BACKGROUND

Snowglobes (or waterglobes) exhibit moving decorative particles within a fluid-filled vessel. To initiate movement of the decorative particles, a user typically shakes the snowglobe manually so as to randomly disperse the decorative particles inside the fluid-filled vessel. As the particles fall back to a resting state at the bottom of the vessel, the ornamental effect mimics snowfall or a shower of confetti. However, the decorative particles soon settle to the bottom of the snowglobe and the ornamental effect of the snowglobe is diminished. As such, frequent manual shaking of the snowglobe is required to maintain the active ornamental effect of the decorative particles. Often, such decorative devices are lighted to enhance their ornamental effect.

Mechanically and/or electrically powered snowglobes are also available that utilize agitators or pumps to automatically disperse the decorative particles in order to increase the ornamental value of the snowglobes. Both the conventional and powered snowglobes are often specifically adapted to simulate snowfall within a display setting. As such, the decorative particles are randomly distributed within the fluid filled vessel when the decorative particles are dispersed and when the dispersion ceases, the decorative particles slowly fall in a random pattern to the base of the snowglobe under force of gravity.

A bubble light is a different type of decorative device that include a liquid-filled enclosure heated at its base. The liquid is often Methylene Chloride, which is toxic and flammable. The heat is sufficient to cause liquid near the base of the enclosure to boil, thereby creating bubbles that randomly rise through the liquid due to reduced buoyancy of the gas as compared to the liquid. The temperature of the liquid falls with distance from the heat source at the base of the enclosure. Therefore, the bubbles dissipate when the temperature of the bubbles is reduced below the boiling point of the liquid. Similarly, lava lamps also use principles of buoyancy to cause heated and liquefied wax at the base of an enclosure to rise upward through a surrounding liquid and then fall downward again in a random pattern as the wax cools.

Such devices suffer from many disadvantages. The requirement of frequent manual shaking diminishes the ornamental effect of the snowglobes when at rest. Further, bubble lights employ toxic and flammable liquids which require a heat source, all of which introduce safety risks.

### SUMMARY

Implementations described and claimed herein address the foregoing problems by providing a flowguide decoration with a viewing vessel (or “flow vessel”) filled with fluid and decorative particles. The flowguide decoration contains at least one flowguide positioned within the viewing vessel. The flowguide and the viewing vessel define one or more flow paths constraining movement of the fluid and the decorative particles within the viewing vessel. A motor-driven impeller imparts motion to the fluid and the decorative particles along the flow path when the impeller is rotating. As a result, the flowguide decoration provides an impeller-driven fluid/decorative particle flow within the view vessel that provides an ornamental effect similar to snowglobes and bubble lights but without the aforementioned disadvantages.

Various implementations also include a light that illuminates one or more of the viewing vessel, flowguide, fluid, and decorative particles; a speaker that plays one or more of songs, sounds, and voices; a battery that powers one or more of the light, speaker, and motor-driven impeller; and/or circuitry that controls one or more of the light, speaker, and motor-driven impeller. Various other implementations are also described and recited herein.

### BRIEF DESCRIPTIONS OF THE DRAWINGS

FIG. 1 illustrates an isometric view of an example flowguide decoration.

FIG. 2 illustrates a sectional view of the example flowguide decoration of FIG. 1 along section lines A-A.

FIG. 3 illustrates a sectional view of the example flowguide decoration of FIG. 1 along section lines B-B.

FIG. 4 illustrates a sectional view of an example flowguide decoration with an auxiliary flowguide.

FIG. 5A illustrates a sectional view of an example flowguide nightlight with a circular flowguide.

FIG. 5B illustrates a side view of the example flowguide nightlight of FIG. 5A.

FIG. 6 illustrates a side view of two example flowguide decorations linked together.

FIG. 7 illustrates an isometric view of an example flowguide decoration with a lighting tube.

FIG. 8 illustrates an isometric view of an example flowguide decoration with a flowguide tube.

FIG. 9 illustrates example operations for operating a flowguide decoration.

### DETAILED DESCRIPTIONS

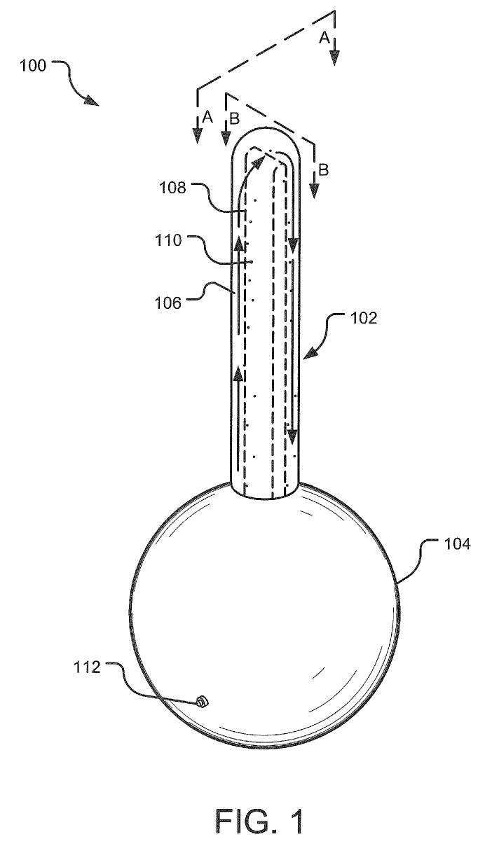

FIG. 1 illustrates an isometric view of an example flowguide decoration 100. The decoration 100 includes a flow vessel 102 partially encompassed by a housing 104. The flow vessel 102 includes fluid 106, which flows around a flowguide 108 that runs through the middle of at least a visible portion of the flow vessel 102. More specifically, in one implementation, the flowguide 108 is attached to two opposite sides of the flow vessel 102. In combination with the interior walls of the flow vessel 102, the flowguide 108 defines a flow path that extends up one side of the flowguide 108 and down the opposite side of the flowguide 108, within the flow vessel 102 as illustrated by the arrows of FIG. 1.

In at least one implementation, the fluid is a non-toxic liquid or gas capable of moving suspended decorative particles along the flow path within the flow vessel. Further, the fluid movement may be achieved through use of an impeller or other flow-inducing mechanism (e.g., a pump). As such, the flowguide decoration 100 does not require additional heating, although additional heating may be used in some implementations. Furthermore, in some implementation, the decoration may propel the particles along the flow path without directly causing a flow of the fluid (e.g., magnetically).

The flow vessel 102 is a partially or totally transparent tube and may have any color pigment or a lack of pigment. Further, while flow vessel 102 has a tubular longitudinal shape, a cross-section of the tube may have any shape with a confined interior area (e.g., a circle, an ellipse, a triangle, a quadrilateral, a hexagon, an octagon, and a star). Still further, the cross-section of the tube may vary over a length of the tube. Additionally, the flow vessel 102 may have any one of a variety of overall shapes (e.g., spherical, cubical, three-dimensional hollow figurine, etc.) and/or posses a variety of graphics on its surfaces corresponding to a desired visual effect (e.g., a Dracula graphic printed on the flow vessel 102 for a Halloween decoration). The flow vessel 102 may be made of any material that possesses partial or complete transparency (e.g., plastics and glass).

The flowguide 108 may be transparent, partially transparent, or opaque. Further, the flowguide 108 may have any color pigment or a lack of pigment and be made of any material. Similar to the flow vessel 102, the flowguide 108 may also have a variety of shapes and/or posses a variety of graphics on its surfaces corresponding to a desired visual effect (e.g., a Dracula graphic printed on the flowguide 108 for a Halloween decoration). In addition, the flowguide 108 may have additional physical features for visual effect. For example, water wheels and/or flippers may be attached to the flowguide 108 that move when the fluid 108 flows through the flow vessel 102 (e.g., the flowguide 108 may resemble a shark with a hinged “flipper feature” that moves or the flowguide 108 may resemble an airplane with a “propeller feature” that rotates). In one implementation, the flowguide is helicoidal (e.g., twisted along a center axis of the flow vessel 102) or of any other shape that provides a varied but defined path within the flow vessel 102. The flowguide 108 may be secured within the interior of the flow vessel 102 via an adhesive, welding, or press-fitting. In another implementation, the flow vessel 102 and flowguide 108 are manufactured together as one component in a molding or extrusion process.

The fluid 106 may be any partially or totally transparent gas or liquid. The fluid 106 may also have any color pigment or a lack of pigment. Example effective liquids include various glycols (e.g., Propylene glycol, which is non-toxic and non-flammable; and Ethylene glycol, which is also non-flammable but toxic when ingested by humans). The fluid 106 also includes decorative particles 110. In one implementation, the decorative particles 110 are circulated within the flow vessel 102 as the fluid 106 moves along the flow paths defined by flow vessel 102 and the flowguide 108. In another implementation, the decorative particles 110 are circulated along the flow paths independently of the fluid, such by the use of magnets. In one implementation, the decorative particles 110 have an equal or nearly equal buoyancy as the fluid 106. As such, the decorative particles 110 remain suspended within the fluid 106 indefinitely or for a long period after the fluid 106 stops moving within the flow vessel 102. In some implementations, the decorative particles 110 eventually settle to the bottom of the flow vessel 102.

The decorative particles 110 may be reflective and may have any color pigment or a lack of pigment. In various implementations, the decorative particles 110 may include glitter, plastic or metal balls, confetti, etc. In addition, the decorative particles 110 may have specific shapes (e.g., bat shaped decorative particles 110 may move around a Dracula shaped flowguide 108). Other specific shapes include miniature cars to simulate a car race, miniature fish to simulate a swimming school of fish, and miniature butterflies. In one implementation, the decorative particles 110 are small diameter translucent balls of varying size that resemble bubbles. In another implementation, the decorative particles 110 are a separate fluid that does not disperse within the fluid 106. These fluid decorative particles 110 appear as bubbles within the fluid 106 as well.

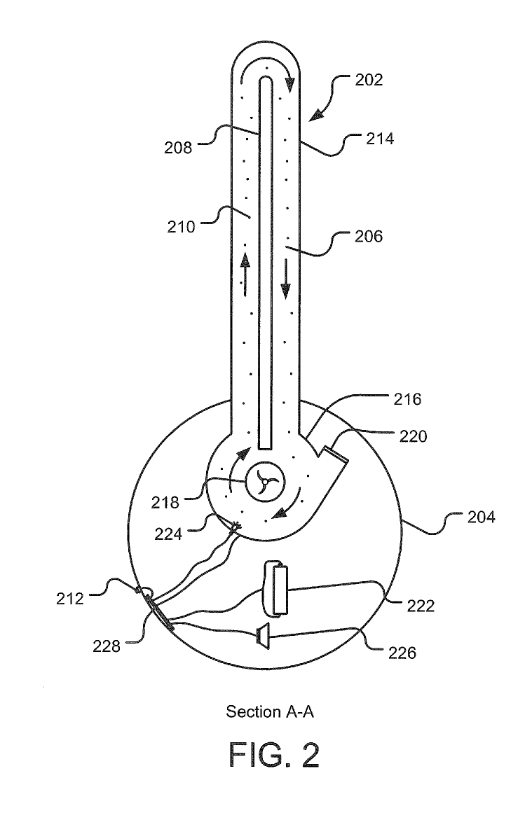

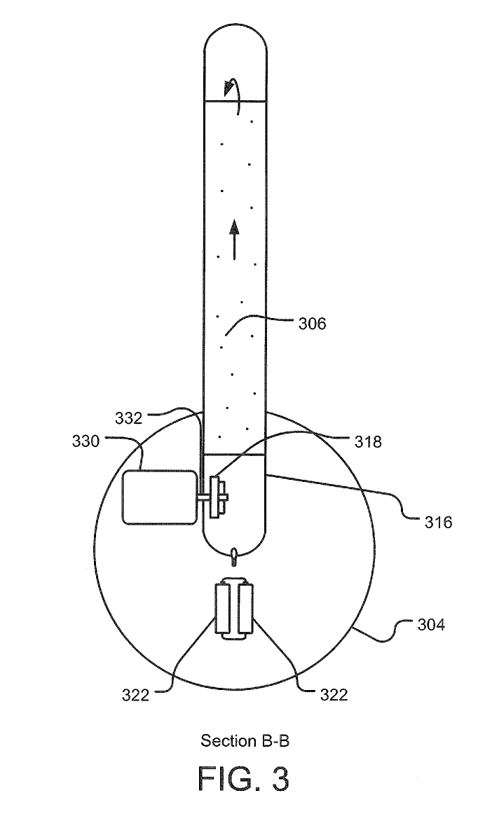

The housing 104 includes functional components of the flowguide decoration 100 not intended to be visible to a user (see FIGS. 2 and 3). As such, the housing 104 is opaque. However, in other implementations, the housing 104 may be transparent or semi-transparent. The housing 104 may be made of any rigid or semi-rigid material (e.g., plastic, paper, glass, metal, and ceramic). Further, while the housing 104 shown in FIG. 1 is spherical, other implementations may employ a housing of any shape with sufficient interior volume to contain the functional components. Similar to the flow vessel 102 and flowguide 108, the housing 104 may have a variety of graphics on its surfaces corresponding to a desired visual effect (e.g., a Dracula graphic printed on the housing 104 for a Halloween decoration). The housing 104 includes a switch 112 used to activate movement of the fluid 106 within the flow vessel 102. Other implementations do not include the switch 112 (e.g., they are turned on by the provision of electrical or other motion inducing power).

FIG. 2 illustrates a sectional view of the example flowguide decoration 100 of FIG. 1 along section line A-A. Flow vessel 202 includes a viewing vessel 214 and a reservoir 216. The viewing vessel 214 portion of the flow vessel 202 is discussed in detail above with regard to FIG. 1. The viewing vessel 214 extends into housing 204 and ends with a reservoir 216. The reservoir 216 contains an impeller 218 that spins to circulate fluid 206 within the flow vessel 202. More specifically, circular motion of the impeller 218 causes the fluid 206 to move upwardly along a first surface of a flowguide 208 and downwardly along a second surface of the flowguide 208. The flowguide 208 extends to a close proximity of the impeller 218 in order to prevent a substantial portion of the fluid 206 from bypassing the viewing vessel 214 and merely circulating within the reservoir 216.

The reservoir 216 fits within the housing 204 and may be any size or shape that allows sufficient space for the impeller 218 to operate. In an implementation where the fluid 206 is a gas, the impeller 218 may instead be a propeller. Other devices for effecting circular motion of the fluid 206 within the flow vessel 202 are also contemplated herein.

The reservoir 216 is also equipped with a fill tube 220. The fill tube 220 allows for the flow vessel 202 to be filled and/or drained of the fluid 206. The fill tube 220 may also be used to isolate gaseous bubbles within the flow vessel 202 when the fluid 206 is a liquid. The fill tube 220 extends out of the reservoir 216 at an upward angle. Any gaseous bubbles that are trapped with the flow vessel 202 may be confined to the fill tube 220 by tilting the flow vessel 202 until the fill tube 220 occupies the highest point of the flow vessel 202. Buoyancy will force the gaseous bubbles into the fill tube 220 where they will remain trapped when the flow vessel 202 is tilted upright. This will keep the gaseous bubbles out of view when an opaque housing 204 is utilized. In some implementations, the fill tube 220 is equipped with a cap so that the flow vessel 202 may be filled and/or drained multiple times. In other implementations, the fill tube 220 is used once to fill the flow vessel 202 and then hermetically sealed shut. In still other implementations, the flow vessel 202 is not equipped with a fill tube 220.

The housing 204 may also include one or more of a battery 222, a light 224, a speaker 226, and control circuitry 228. The battery 222 includes one or more individual battery cells of any size (e.g., button cell, 9-volt, AAA, AA) that will fit within the housing 204. In other implementations, the battery 222 is located outside of the housing 204. Further, the battery 222 may be rechargeable or single use and utilize any suitable chemical composition (e.g., alkaline, lithium, NiCd, NiMh, and Lithium ion). If the battery 222 is rechargeable, an electrical connection may extend from the battery 222 to an electrical port on the housing 222 used for charging the battery 222. The battery 222 powers the various components of the flowguide decoration (e.g., a motor, as shown in FIG. 3, driving the impeller 218; the light 224; the speaker 226; and the control circuitry 228). In other implementations, the flowguide decoration does not include a battery 222. Instead, the flowguide decoration includes an electrical connection extending outside of the housing 222 to an external power source (e.g., an electrical distribution grid) to power the flowguide decoration.

The light 224 is any electrically powered light source that will fit within the housing 204 (e.g., an incandescent lamp, electroluminescent lamp such as a light-emitting diode, gas-discharge lamp, high-intensity discharge lamp, etc.). In the implementation shown in FIG. 2, the light 224 is embedded within a wall of the reservoir 216 to illuminate the fluid 206 and decorative particles 210 from within the flow vessel 202, which results in a visually attractive display to a user. In other implementations, the light 224 is located elsewhere in the housing 204 and illuminates the fluid 206 and decorative particles 210 from within the flow vessel 202 by first passing light rays through the transparent or semi-transparent reservoir 216. The light 224 may be any color of the visible spectrum at any intensity. Further, the light 224 may change color, intensity, and/or flash at any fixed or varying rate. In other implementations, the flowguide decoration does not include a light 224.

The speaker 226 is any device that converts an electrical signal into sounds or vibration that will fit within the housing 204. The speaker 226 may play one or more songs corresponding to a chosen theme for the flowguide decoration (e.g., the song “Silent Night” for a Christmas decoration). The speaker 226 may also play one or more sounds (e.g., a creaking door for a Halloween decoration) and/or voices (e.g., “Ho Ho Ho” for a Christmas decoration). Further, the songs, sounds, and/or voices emanating from the speaker 226 may change volume and/or play at any fixed or varying rate. In some implementations, the speaker 226 is oriented such that any songs, sounds, and/or voices are directed out of one or more apertures (not shown) in the housing 204. In other implementations, the flowguide decoration does not include a speaker 226.

The control circuitry 228 controls operation of one or both of the light 224 and the speaker 226. More specifically, the circuitry 228 controls when and how much power is supplied from the battery 222 to the light 224 and/or the speaker 226. Further, the circuitry 228 may control on/off operation of the light 224; change the color and/or intensity of the light 224; and/or flash the light 224 at any fixed or varying rate. Further, the circuitry 228 may control on/off operation of the speaker 226; change speaker volume; store and send one or more songs, sounds, and/or voices to the speaker 226; and/or select a fixed or varying rate for playing the songs, sounds, and/or voices. In one implementation, the circuitry 228 includes multiple individual electronic components mounted on one or more circuit boards. Further, the circuitry 228 may include one or more integrated circuits.

A user may control the circuitry 228 by manipulating a switch 212. In one implementation, the user manipulates the switch 212 to turn the circuitry 228 on and off. The switch 212 may be a button, slider, knob, touch-sensitive surface, or any other user-input device. Further, there may be multiple switches 212 that control the function of the flowguide decoration components (e.g., the light 224 and the speaker 226). For example, the switch 212 may include a volume control for the speaker 226 and an intensity control for the light 224. Still further, the flowguide decoration may include one or more noise or motion sensors that activate one or more components of the flowguide decoration 200 in the presence of motion or noise.

FIG. 3 illustrates a sectional view of the example flowguide decoration 100 of FIG. 1 along section line B-B. An impeller 318 is connected to a motor 330 via a shaft 332. The shaft 332 extends through the wall of a reservoir 316 so that the motor 330 is outside of the reservoir 316 and the impeller 318 is within the reservoir 316. A seal is provided where the shaft 332 penetrates the reservoir 316 to prevent fluid 306 from entering or exiting the reservoir 316 around the shaft 332.

In other implementations, the impeller 318 is connected to the motor 330 via a magnetic field rather than the physical shaft 332. A changing magnetic field produced by the motor 330 causes metallic and/or magnetic material within the impeller 318 to move and rotate the impeller 318. In some implementations, no physical shaft 332 is present and the impeller 318 rotates within a confined space within the housing 304. In other implementations, the physical shaft 332 is fixed to the wall of the reservoir 316 but does not extend through the wall of the reservoir 316, so that the impeller 318 rotates in a fixed position using the magnetic field. If the physical shaft 332 does not penetrate the reservoir 316 wall, no shaft 332 seal is required.

The motor 330 is any device that uses electrical energy (i.e., AC or DC current) to produce rotational mechanical energy. Control circuitry (shown in FIG. 2) controls operation of the motor 330. More specifically, the circuitry controls when and how much power is supplied from battery 322 to the motor 330. Further, the circuitry may control on/off operation of the motor 330; change the speed or direction of the motor 330; and/or pulse the motor 330 at any fixed or varying rate. Still further, a user may operate the motor 330 by manipulating a switch (shown in FIG. 2). Varying the speed and/or direction of the motor 330 yields a corresponding change in the speed and/or direction of the impeller 318, which in turn yields a change in the speed and/or direction of fluid 306 flowing through the flowguide decoration.

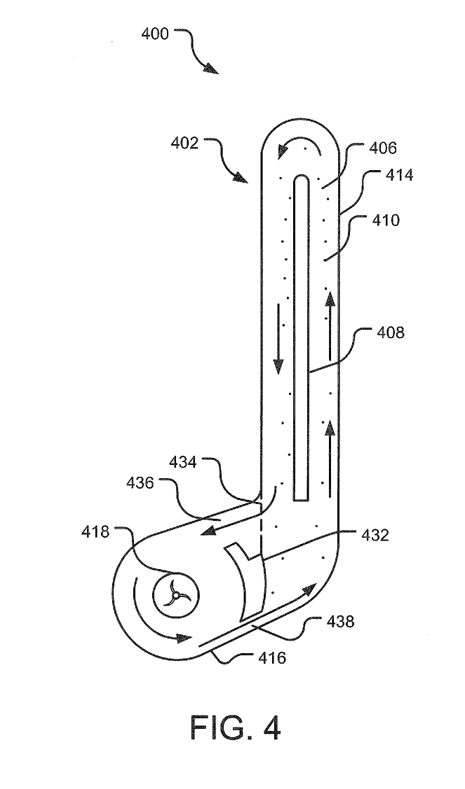

FIG. 4 illustrates a sectional view of an example flowguide decoration 400 with an auxiliary flowguide 432. The flowguide decoration 400 operates in a similar fashion as the flowguide decoration 100 of FIGS. 1-3 with the following distinctions. A reservoir 416 with corresponding impeller 418 is shifted to the side at the bottom of the flow vessel 402. Further, the reservoir 416 is isolated from a viewing vessel 414 using the auxiliary flowguide 432 and a screen 434.

The screen 434 allows fluid 406 to enter the reservoir 416 from the viewing vessel 414 via an entrance 436 defined by the auxiliary flowguide 432 and the exterior of the flow vessel 402 while keeping decorative particles 410 isolated within the viewing vessel 414. The fluid 406 flows around impeller 418 and exits the reservoir 416 via an exit 438 defined by the auxiliary flowguide 432 and the exterior of the flow vessel 402. Any decorative particles 410 that build up in front of the screen 434 eventually fall off due to the force of gravity, especially when the impeller 418 stops rotating. Decorative particles 410 that fall off the screen are reintroduced into the fluid 406 flow as they fall downward in front of the exit 438.

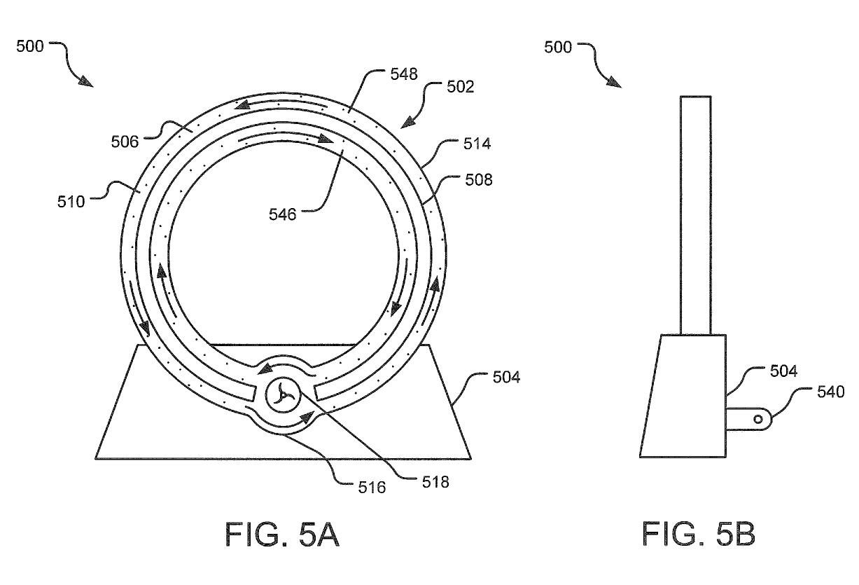

FIG. 5A illustrates a section view of an example flowguide nightlight 500 with a semi-circular flowguide 508. The flowguide nightlight 500 operates in a similar fashion as the flowguide decorations 100 & 400 of FIGS. 1-4 with the following distinctions. Both flow vessel 502 and the flowguide 508 within the flow vessel 502 are formed to be partially circular with a reservoir 516 connecting ends of the partially circular flow vessel 502 together within a housing 504. As discussed with regard to FIGS. 1-4, the housing 504, flow vessel 502, reservoir 516, and/or flowguide 508 may have varying shapes, sizes, and features. For example, in one implementation, the flowguide 508 is helicoidal, which provides a spiral flow path of fluid and decorative particles along the length of the partially circular flow vessel 502.

An impeller 518 rotates counter-clockwise effecting clockwise movement of fluid 506 and decorative particles 510 in an inner channel 546 of the viewing tube 514. Further, counter-clockwise rotation of the impeller 518 effects counter-clockwise movement of the fluid 506 and decorative particles 510 in an outer channel 548 of the viewing tube 514. Similarly, clockwise rotation of the impeller 518 effects movement of the fluid 506 and decorative particles 510 counter-clockwise and clockwise in the inner channel 546 and outer channel 548, respectively.

FIG. 5B illustrates a side view of the example flowguide nightlight 500 of FIG. 5A. The flowguide nightlight 500 is equipped with one or more electrical terminals 540 that extend out of housing 504 from electrical components contained within the housing 504. The electrical terminals 540 connect the flowguide nightlight 500 to any external power source (e.g., commercially available AC power, a DC storage battery, AC or DC power supplied by a combustion generator). The electrical terminals 540 include any power plug or socket style suitable for a variety of power types and countries.

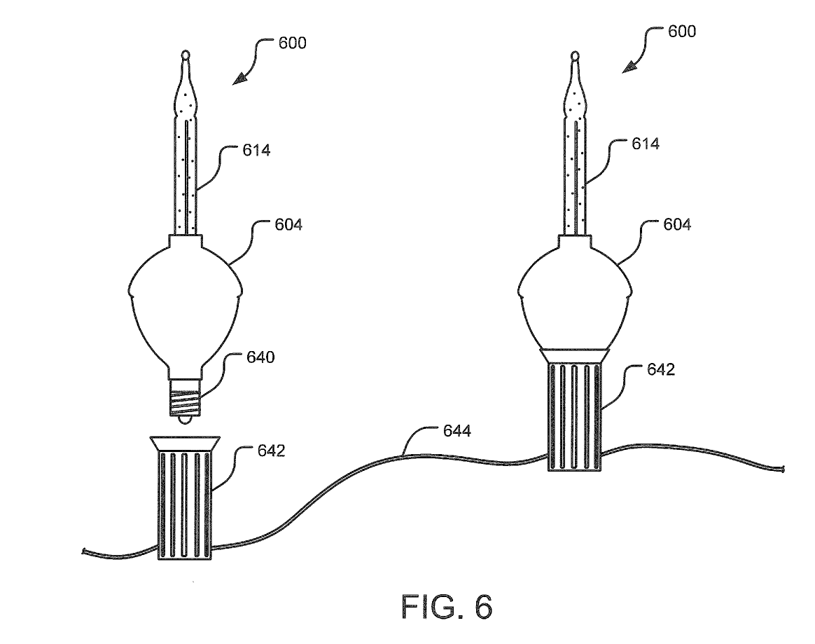

FIG. 6 illustrates a side view of two example flowguide decorations 600 linked together. The flowguide decorations 600 are functionally similar to the flowguide decoration 100 depicted in FIGS. 1-3 except that flowguide decorations 600 each include an external screw-type electrical terminal 640 in lieu of an internal battery. This electrical terminal 640 may be used in conjunction with a corresponding screw-type receptacle 642 to create an electrical connection with an electric cord 644 that carries electricity from any electric power source. The electric cord 644 may contain multiple wires. The electrical terminals 640 and receptacles 642 can be a variety of standard light bulb bases and receptacles or any other electrical plugs and sockets. In other implementations, the electrical terminals 640 and corresponding receptacles 642 are unique to the flowguide decorations 600.

The flowguide decorations 600 vary from the flowguide decoration 100 depicted in FIGS. 1-3 in several decorative ways, as well. The flowguide decorations 600 utilize viewing vessels 614 with a top styled to resemble a candle flame. In other implementations, the viewing vessels 614 resemble candy canes. Further, the flowguide decorations 600 utilize a stylized housing 604 that differs from the spherical housing 104 of FIGS. 1-3.

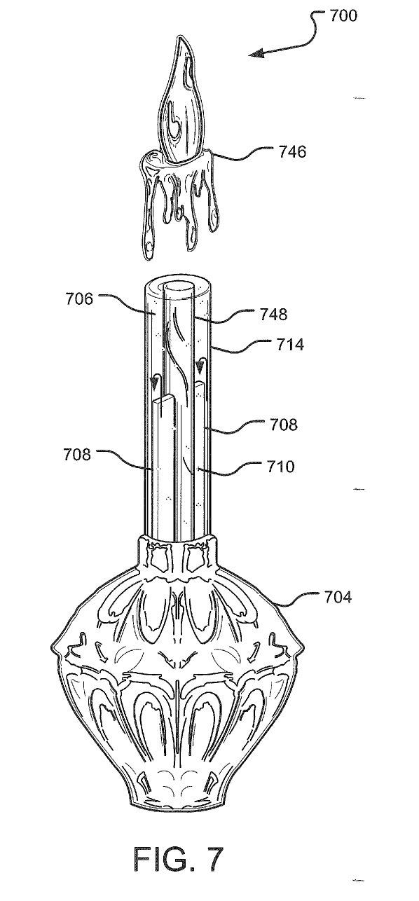

FIG. 7 illustrates an isometric view of an example flowguide decoration 700 with a lighting tube 748. The flowguide decoration 700 is functionally similar to the flowguide decorations 100, 600 depicted in FIGS. 1-3 & 6 except that flowguide decoration 700 includes the lighting tube 748 that delivers light to a top 746 styled to resemble a candle flame with melted wax. The top 746 is shown detached from the rest of the flowguide decoration 700 for illustration purposes. In operation, the top 746 is attached to the flowguide decoration 700 similar to flowguide decoration 600 of FIG. 6. The top 746 is partially or totally transparent and may have any color pigment or a lack of pigment. Further, the top 746 may also have a variety of shapes and/or posses a variety of graphics on its surfaces corresponding to a desired visual effect.

In one implementation, the lighting tube 748 contains one or more voids or fibre-optics that transmit light generated within a housing 704 to the top 746. In another implementation, the lighting tube 748 contains wires that transmit electricity that powers a light source within the top 746. As a result, the “candle” appears to be lit. The lighting tube 748 may be fluid filled or solid around the voids, fibre-optics, and/or wires that extend through the lighting tube 748.

The flowguide 708 of FIG. 7 is functionally similar to the flowguides depicted in FIGS. 1-3 & 6 except that the lighting tube 748 passes through the middle of the flowguide 708. Fluid 706 and decorative particles 710 still flow around the flowguide 708 within viewing tube 714 as indicated by the arrows and described in detail with regard to FIGS. 1-3 & 6. Further, the flowguide decoration 700 utilizes a stylized housing 704 similar to stylized housing 604 of FIG. 6 with additional decorative patterns.

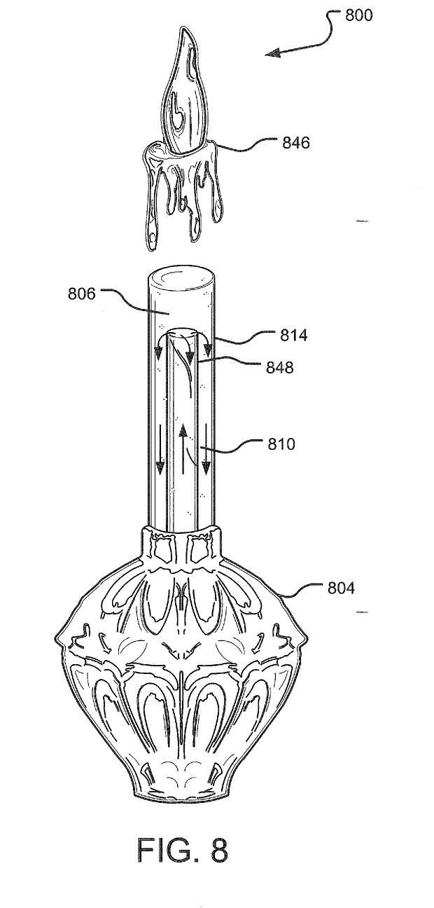

FIG. 8 illustrates an isometric view of an example flowguide decoration 800 with a flowguide tube 848. As compared with the flowguide decoration 700 of FIG. 7, tube 848 is used as a flowguide instead of a passage for light and/or electricity for top 846. As tube 848 is the flowguide in FIG. 8, a flowguide corresponding to flowguide 708 of FIG. 7 is not present in FIG. 8. In other implementations, a flowguide corresponding to the flowguide 708 of FIG. 7 may be present in FIG. 8 to work in conjunction with the flowguide tube 848 to direct fluid 806 and decorative particles 810 through the flowguide decoration 800.

The fluid 806 and decorative particles 810 flow from housing 804 up through the flowguide tube 848, out the top of the flowguide tube 848, and back down between flowguide tube 848 and viewing tube 814 into the housing 804 as indicated by the arrows. In another implementation, the fluid 806 and decorative particles 810 flow from the housing 804 up between the flowguide tube 848 and the viewing tube 814, into the top of the flowguide tube 848, and back down through the flowguide tube 848 into the housing 804. In yet another implementation, there are one or more small apertures in the flowguide tube 848 along a length of the flowguide tube 848 through which the fluid 806 and decorative particles 810 flow into the flowguide tube 848 from the space between the flowguide tube 848 and the viewing tube 814, and/or vice versa.

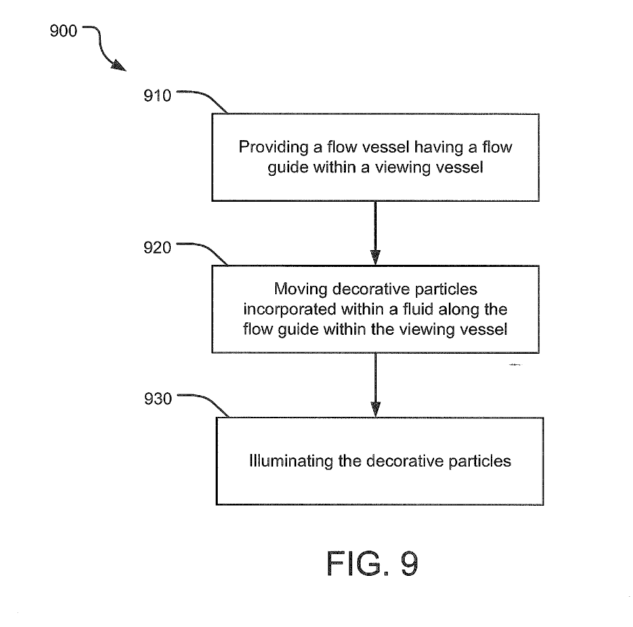

FIG. 9 illustrates example operations 900 for operating a flowguide decoration. A providing operation 910 provides a flow vessel having a flowguide within a see-through (e.g., transparent or translucent) viewing vessel. The flow guide and the flow vessel define a path through the flow vessel for a fluid and decorative particles to circulate.

In a moving operation 920, the impeller circulates the fluid along one or more flow paths defined by the flow guide within the flow vessel, thereby moving the decorative particles along the same flow paths. For example, in one implementation, an impeller imparts motion to the fluid and decorative particles within the flow vessel. In some implementations, circulation of the fluid and decorative particles starts and stops periodically or arbitrarily to enhance the ornamental effect.

In an illumination operation 930, the decorative particles are illuminated. The illumination may change color and/or intensity over time. Further audio content such as sounds, voices, and/or music can be played. The circulation, illumination, and audio content may be coordinated to present an aesthetically pleasing audio/visual display. For example, the illumination and/or circulation may be timed to correspond to changes in the audio content.

It should be understood that flow guides may be employed with many different shapes of flow vessels. In addition to the examples already described, a flow guide may be secured within a disc-like flow vessel in a spiral pattern that spirals in on itself from the outermost radius of the disc to the innermost radius of the disc. In this example, the flow guide provides a more complicated pattern of flow paths than those shown in the Figures. Further, in some implementations, a more significant current must be maintained to effectively propel the decorative particles along the more complicated patterns of flow paths. In such cases, multiple impellers or pumps may be employed to achieve satisfactory results.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. A flowguide decoration comprising:
a viewing vessel containing fluid and decorative particles;
a motion-inducing mechanism configured to impart motion to the fluid and the decorative particles along a flow path within the viewing vessel;
a flowguide positioned within the viewing vessel that defines the flow path for movement of the fluid and the decorative particles to and from the motion-inducing mechanism.

2. The flowguide decoration of claim 1, further comprising:
a light configured to illuminate one or more of the viewing vessel, flowguide, fluid, and decorative particles.

3. The flowguide decoration of claim 2, wherein the light is a light-emitting diode.

4. The flowguide decoration of claim 1, wherein the flow path is a closed loop.

5. The flowguide decoration of claim 1, wherein the decorative particles are reflective.

6. The flowguide decoration of claim 1, wherein the viewing vessel is generally cylindrical.

7. The flowguide decoration of claim 1, wherein the flowguide is generally planar.

8. The flowguide decoration of claim 1, wherein the viewing vessel and the flowguide form a partially circular flow path.

9. The flowguide decoration of claim 1, further comprising:
an electrical teiminal configured to be plugged into an electrical receptacle.

10. The flowguide decoration of claim 1 wherein the flowguide induces a helicoidal flow of the fluid and particles within the viewing vessel.

11. The flowguide decoration of claim 1 wherein the motion-inducing mechanism includes a rotatable impeller.

12. A method of operating a flowguide decoration, the method comprising:
providing a viewing vessel containing fluid and decorative particles;
providing a flowguide positioned within the viewing vessel that defines the flow path for movement of the fluid and the decorative particles to and from a motion-inducing mechanism also within the viewing vessel; and
moving the fluid and the decorative particles along the flow path using the motion-inducing mechanism.

13. The method of claim 12, further comprising:
illuminating one or more of the viewing vessel, flowguide, fluid, and decorative particles from within the flowguide decoration.

14. The method of claim 13, wherein one or more of the viewing vessel, flowguide, fluid, and decorative particles are illuminated using a light-emitting diode.

15. The method of claim 12, wherein the flow path is a closed loop.

16. The method of claim 12, wherein the viewing vessel is generally cylindrical.

17. The method of claim 12, wherein the viewing vessel and the flowguide form a partially circular flow path.

18. The method of claim 12, wherein the flowguide induces a helicoidal flow of the fluid and particles within the viewing vessel.

19. A flowguide decoration comprising:
a generally cylindrical viewing vessel containing fluid and decorative particles;
a motion-inducing mechanism configured to impart motion to the fluid and the decorative particles along a flow path within the viewing vessel;
a generally planar flowguide positioned within the viewing vessel that defines a flow path for movement of the fluid and the decorative particles to and from the motion-inducing mechanism;
a light configured to illuminate one or more of the viewing vessel, flowguide, fluid, and decorative particles.

20. The flowguide decoration of claim 19, wherein one or both of the motion-inducing mechanism and the light are cycled on and off sequentially.
